(19) United States
(12) Patent Application Publication
(10) Pub. No.: US 2006/0021592 A1
(43) Pub. Date: Feb. 2, 2006

(54) Heater box for an engine

(76) Inventors: Stephen J. Ryczek, Hartland, WI (US); James D. Makiya, Wauwatosa, WI (US); William M. Kindness, Franklin, WI (US); Kyle Clasen, Hartford, WI (US)

Correspondence Address: MICHAEL BEST & FRIEDRICH, LLP, 100 E WISCONSIN AVENUE, MILWAUKEE, WI, 53202, US

(21) Appl. No.: 10/902,337

(22) Filed: Jul. 29, 2004

(51) Int. Cl. F02M 35/10; F02B 77/04

(52) U.S. Cl. 123/184.21; 123/198 E

(57) ABSTRACT

An engine generally including a housing, an air/fuel mixing device coupled to the housing, and a cover coupled to the housing and cooperating with the housing to define a space. A muffler is disposed adjacent the space and is operable to heat air within the space. A flow guide is positioned adjacent the space. The flow guide includes a channel sized to deliver a predetermined quantity of air from the space to the air/fuel mixing device.

### BACKGROUND

The present invention relates generally to cold weather engines. More particularly, the present invention relates to cold weather engines that provide heated air for combustion.

Snow throwers and other cold weather equipment often use small engines to provide the necessary power. These engines often include an air/fuel mixing device such as a carburetor that operates most efficiently (i.e., fuel efficiency as well as reduced emissions) when the air is provided to the carburetor within a specified temperature range. When operating in a cold environment it is often difficult to provide sufficient quantities of warm air to the carburetor to operate within this predefined range. This results in inefficient operation and higher emissions than would be achieved with optimal temperature air.

### SUMMARY

The present invention provides an engine generally including a housing, an air/fuel mixing device coupled to the housing, and a cover coupled to the housing and cooperating with the housing to define a space. A muffler is disposed adjacent the space and is operable to heat air within the space. A flow guide is positioned adjacent the space. The flow guide includes a channel sized to deliver a predetermined quantity of air from the space to the air/fuel mixing device.

In another aspect, the invention generally provides an engine including a housing, a cylinder disposed within the housing, and a piston reciprocal within the cylinder and cooperating with the cylinder to define a characteristic volume. An air/fuel mixing device is coupled to the housing and is operable to mix a flow of fuel and a flow of heated air to produce an air/fuel mixture. A muffler is positioned adjacent the housing and a cover is coupled to the housing. The housing, the cover, and the muffler cooperate to substantially enclose a space. A flow guide is positioned adjacent the space and includes a channel having a flow area. The flow area is selected based upon the characteristic volume. The channel is positioned to deliver the flow of heated air from the space to the air/fuel mixing device.

In still another aspect, the present invention generally provides an engine including a housing and a piston/cylinder arrangement disposed at least partially within the housing and having a characteristic volume. A carburetor is coupled to the housing. A heater box is at least partially defined by the housing. The heater box defines a space and includes a flow limiter having a flow area that is related to the characteristic size. A muffler is positioned adjacent the housing and is disposed adjacent the heater box. The muffler is operable to heat air disposed within the space.

Additional features and advantages will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of an engine including a cover;

FIG. 2 is a perspective view of the engine of FIG. 1 with the cover removed;

FIG. 3 is a side view of the engine of FIG. 1 partially broken away to show a heater box;

FIG. 4 is a perspective view of the exterior of the cover of FIG. 1;

FIG. 5 is bottom view of the cover of FIG. 1;

FIG. 6 is a perspective view of a flow guide;

FIG. 7 is a section view of the flow guide of FIG. 6 taken along line 7-7;

FIG. 8 is a schematic illustration of a piston-cylinder arrangement;

FIG. 9 is a perspective view of another flow guide; and

FIG. 10 is a perspective view of another engine cover.

### DETAILED DESCRIPTION

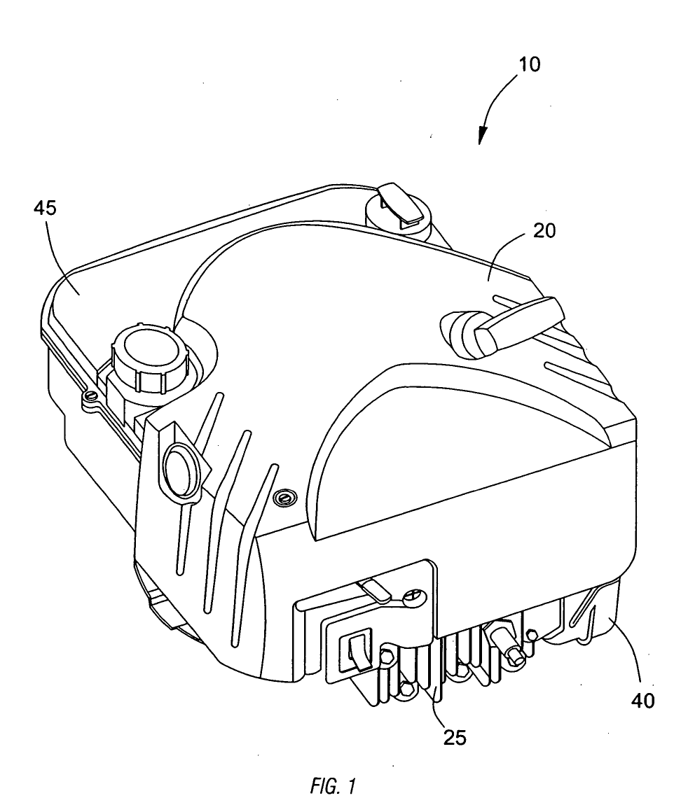

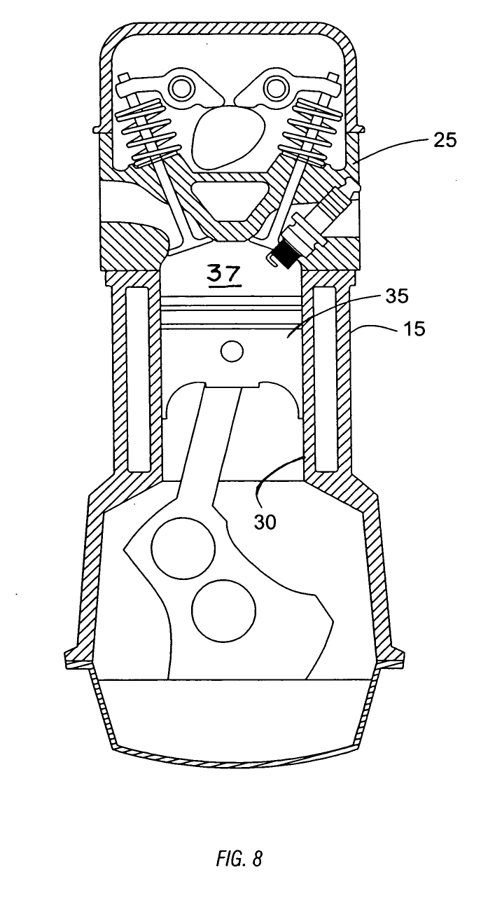

With reference to FIG. 1, an engine 10 including a housing 15 and a cover 20 is illustrated. The engine 10 also includes a cylinder head 25, a cylinder 30, and a piston 35 that reciprocates within the cylinder 30 to drive a crankshaft. The crankshaft extends vertically from the bottom of the engine housing 15 and engages equipment for the engine 10 to drive. The cylinder head 25, the piston 35, and the cylinder 30 cooperate to at least partially define a combustion chamber 37 (shown in FIG. 8) having a characteristic configuration or volume. The characteristic volume is a function of the size of the piston 35 and cylinder 30 as well as the geometry of the various components. For example, some constructions employ a cylinder head 25 that defines a portion of the combustion chamber 37. The shape as well as the volume of this portion affects the volume of the combustion chamber 37.

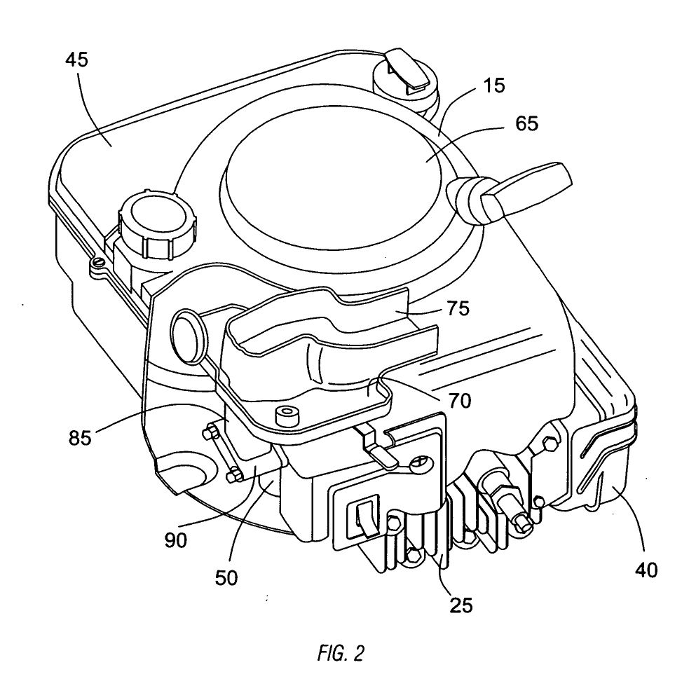

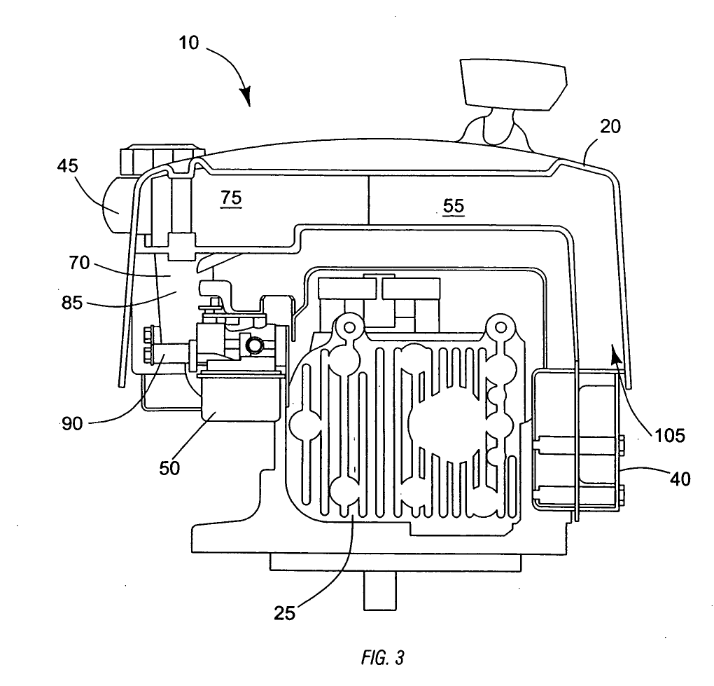

The engine housing 15 at least partially defines the cylinder 30 and provides support for various other components such as a muffler 40, a fuel tank 45, and a carburetor 50. The carburetor 50, shown in FIGS. 2 and 3, receives a flow of fuel from the fuel tank 45 and mixes it with a flow of air to produce an air/fuel mixture. The air/fuel mixture than flows to the combustion chamber 37 for combustion. After combustion, the piston 35 forces exhaust gas out of the combustion chamber. The exhaust gas passes through the muffler 40 and out of the engine 10. The flow of exhaust gas within the muffler 40 is quite hot and functions to heat the muffler 40.

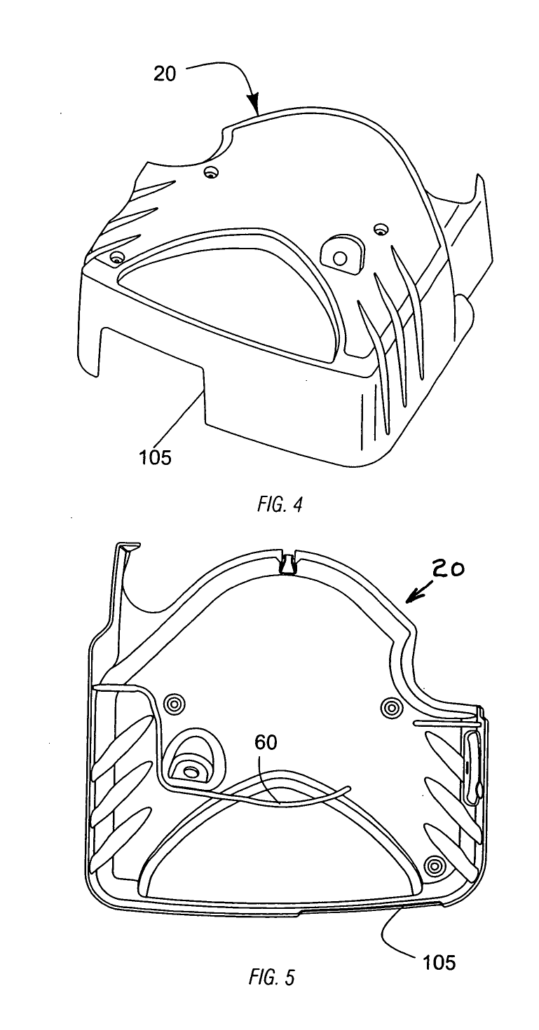

The cover 20, shown in FIGS. 1 and 4-5, engages the engine housing 15 and cooperates with the engine housing 15 and other engine components to define a substantially enclosed chamber 55. The cover 20 is a generally thin-walled member formed to closely fit with the various engine components to substantially seal the chamber 55. The cover 20 can be formed from plastic, metal, composite, or any other material suitable for use with engines 10. The cover 20, or housing 15, may also include seal members (e.g., stick-on rubber strips) that attach to the cover 20, or other component in contact with the cover 20, and engage the other components to provide an improved seal. Of course, air leakage into or out of the chamber 55 may occur, as an air tight seal is not critical to the function of the invention.

The cover 20 includes an interior wall 60, illustrated in FIG. 5, that separates the chamber 55 from other engine components such as a fan 65. The interior wall 60 can be formed as part of the cover 20, may be separate from the cover 20, or may be attached to the cover 20. The shape and position of the wall 60 is largely determined by the available space under the cover 20. As such, many different arrangements of the interior wall 60 are possible.

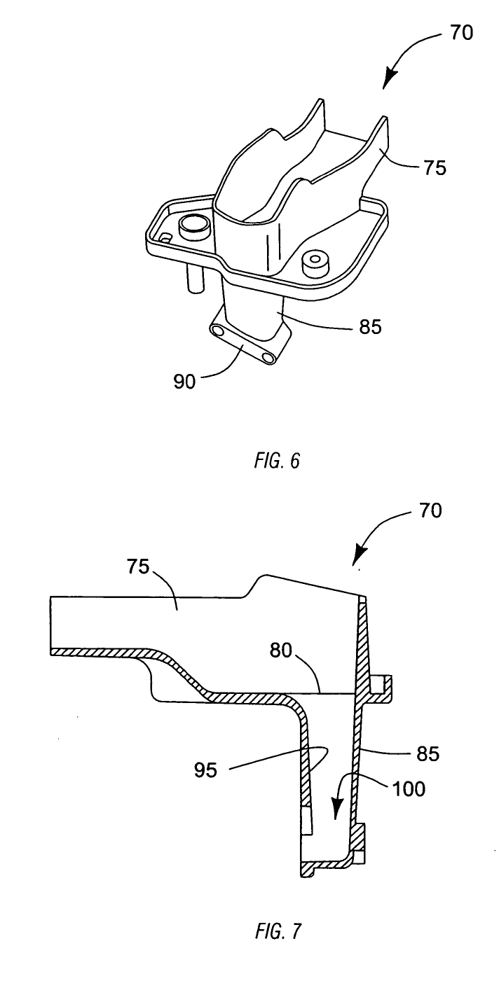

FIGS. 2 and 6-7 illustrate a flow guide 70 that is positioned adjacent the chamber. The flow guide 70 includes a wall portion 75 that cooperates with the interior wall 60 of the cover 20 to separate the chamber 55 from the other engine components. The wall portion 75 is contoured to allow it to fit within the confined space defined by the housing 15 and the cover 20. As such, the wall portion 75 may include turns or elevation changes that allow for a more compact engine 10. The contours of the wall portion 75 function to conserve space. As such, different engines 10 may require different wall contours.

The wall portion 75 also includes an aperture 80 that provides fluid communication between the chamber 55 and the carburetor 50. A tube portion 85 extends between the aperture 80 and the carburetor 50 to complete a flow path between the chamber 55 and the carburetor 50. The tube 85 includes an attachment portion 90 that attaches directly to the carburetor air intake. The tube portion 85 also includes a channel 95 having a throat region 100 that defines a minimum flow area. The minimum flow area is sized based at least partially on the characteristic volume of the combustion chamber 37. More specifically, the carburetor 50 is designed to deliver a precise air/fuel mixture to the combustion chamber 37 and the air cleaner is designed to allow the proper volume of air to pass through the carburetor 50 for a given vacuum. The throat region 100 is sized to allow substantially the same volume of air to pass as the air cleaner. In this way, the throat region 100 does not create an additional flow constraint. Channel 95 and throat regions 100, together with the carburetor venturi, are sized to create the correct partial vacuum during the intake stroke to draw in the correct proportion of fuel and air into the combustion chamber.

In most constructions, the tube portion 85 and the wall portion 75 are formed as a single component. However, other constructions may employ two or more separate components that attach to one another to define the flow guide 70. Constructions that employ separate components have additional sources of potential leakage at the interface between the components. As such, gaskets or other seal-aiding devices (e.g., grease, o-rings, and the like) may be required.

As shown in FIG. 3, with the cover 20 installed in its operating position, the chamber 55 completes a fluid connection between the exterior of the muffler 40 and the carburetor inlet. The muffler 40 is positioned adjacent an open portion 105 of the cover 20. Thus, air entering the chamber 55 through the open portion 105 passes near, and is heated by the hot muffler 40. The heated air fills the chamber 55 and is drawn from the chamber 55 by the carburetor 50 via the tube 85, as required by the engine 10.

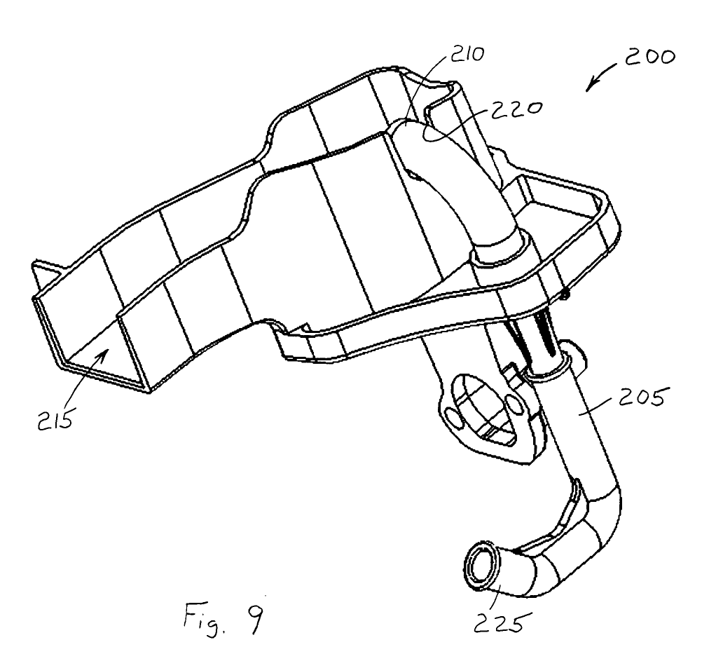

FIG. 9 illustrates another construction of a flow guide 200 that includes a breather tube 205. A first end 210 of the breather tube extends into an interior region 215 of the flow guide via a cut out portion 220. A second end 225 of the tube 205 connects with the engine breather assembly where combustible gasses sometimes collect. These gasses are often very moist, thus making them susceptible to freezing in cold operating climates. When the engine is operating, a partial vacuum is produced adjacent the first end 210 of the tube 205. The partial vacuum draws gasses from the breather and directs them into the carburetor and the engine for combustion.

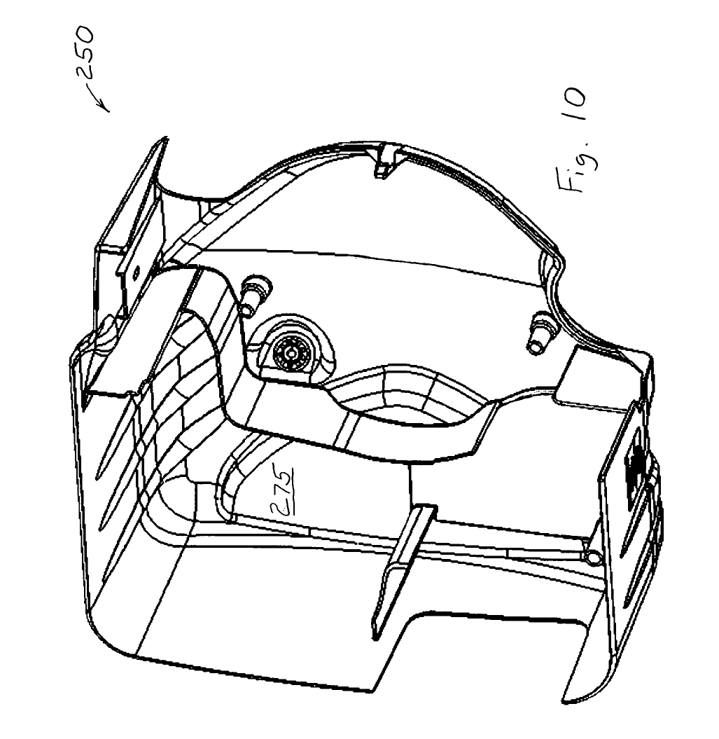

FIG. 10 illustrates another construction of an engine cover 250. The cover 250 is substantially similar to the cover 20 of FIG. 1. The cover 250 includes an interior wall 255 that is substantially similar to, and functions much the same as, the interior wall 60. The cover 250 also includes a second interior wall 260, a transverse wall 265, and a cover portion 270. The second interior wall 260, the transverse wall 265, and the first interior wall 255 cooperate to separate the inlet of the flow guide 200 from areas where cold air might collect. Thus, as the engine produces a vacuum to draw in combustion air, a larger percentage of the air is drawn from a chamber 275 adjacent the hot engine components, including the muffler 40 (shown in FIG. 2).

The cover portion 270 includes a resilient material, such as but not limited to foam (shown in FIG. 10). The cover portion 270 attaches to the inner surface of the cover 250 immediately above the flow guide 200. When the cover 250 is positioned in place, the foam contacts the flow guide 200 and substantially seals the open top of the flow guide 200. In another construction, a rigid cover (e.g., plastic, composite, metal, ceramic, and the like) may be integrally-formed with the flow guide 200 to inhibit the entry of air into the flow guide 200 from above. Again, the cover forces a larger percentage of the air used for combustion to be drawn from the chamber 275 immediately surrounding the muffler 40 and other hot engine components.

During engine operation, the carburetor 50 produces a partial vacuum at its air inlet. The partial vacuum draws the desired quantity of air from the chamber 55 into the carburetor 50. Because the air inlet is directly connected to the tube portion 85 of the flow guide 70, the low-pressure produced by the carburetor 50 draws air from the chamber 55 into the tube 85. The throat 100 helps to determine the quantity of air that can be drawn by the carburetor 50. The air drawn in by the carburetor 50 mixes with a flow of fuel and enters the combustion chamber 37. Once in the combustion chamber 37, the air/fuel mixture is combusted to produce usable power and exhaust gas. The exhaust gas is expelled from the combustion chamber 37 and directed to the muffler 40. The muffler 40 quiets the exhaust flow before finally discharging it to the atmosphere. The exhaust flow remains quite hot even as it exits the muffler 40. As such, the muffler 40 also gets quite hot. The muffler's location adjacent the chamber 55 allows the hot muffler 40 to heat air within the chamber 55 and to heat any air that may enter the chamber 55 adjacent the muffler 40. The heated air remains in the chamber 55 until it is drawn from the chamber 55 by the carburetor 50. Thus, the carburetor 50 provides all of the motive force required to draw heated air for the engine 10, while the chamber 55 serves as a hot air reservoir. It should be noted that the minimum flow area defined by the throat 100 is the minimum flow area in the tube portion 85 only. The carburetor 50 or other engine components may define a flow area that is smaller than the minimum flow area of the tube portion 85.

The system just described is capable of providing air to the carburetor 50 that is at least 20 degrees F. hotter than the ambient air in which the engine 10 operates. In some constructions, even greater air temperature increases are achievable.

Although the invention has been described in detail with reference to certain preferred embodiments, variations and modifications exist within the scope and spirit of the invention as described and defined in the following claims.

What is claimed is:

1. An engine comprising:
a housing;
an air/fuel mixing device coupled to the housing;
a cover coupled to the housing and cooperating with the housing to define a space;
a muffler disposed adjacent the space and operable to heat air within the space; and
a flow guide adjacent the space, the flow guide including a channel sized to deliver a predetermined quantity of air from the space to the air/fuel mixing device.

2. The engine of claim 1, wherein the housing, the cover, and the muffler substantially enclose the space.

3. The engine of claim 1, wherein the engine includes a combustion chamber having a characteristic configuration, and wherein the channel size is related to the characteristic configuration.

4. The engine of claim 3, wherein the characteristic configuration is related to a volume of the combustion chamber and the geometrical arrangement of the combustion chamber.

5. The engine of claim 1, wherein the channel includes a minimum flow area portion defining a minimum flow area, and wherein the minimum flow area is functionally related to a selected partial vacuum in the air/fuel mixing device.

6. The engine of claim 1, wherein the engine includes a breather and wherein a flow path extends from the breather to the flow guide to draw gas from the breather to the air/fuel mixing device.

7. The engine of claim 1, wherein the cover includes a resilient material that contacts the flow guide to at least partially enclose the channel.

8. The engine of claim 1, wherein the air/fuel mixing device is a carburetor.

9. An engine comprising:
a housing;
a cylinder disposed within the housing;
a piston reciprocal within the cylinder and cooperating with the cylinder to define a characteristic volume;
an air/fuel mixing device coupled to the housing and operable to mix a flow of fuel and a flow of heated air to produce an air/fuel mixture;
a muffler adjacent the housing;
a cover coupled to the housing, the housing, the cover, and the muffler cooperating to substantially enclose a space; and
a flow guide adjacent the space and including a channel having a flow area, the flow area being selected based upon the characteristic volume, the channel positioned to deliver the flow of heated air from the space to the air/fuel mixing device.

10. The engine of claim 9, wherein the piston and cylinder cooperate to define a combustion chamber, and wherein the characteristic volume is related to a volume of the combustion chamber.

11. The engine of claim 10, wherein the flow area is a minimum flow area, and wherein the minimum flow area is related to a selected partial vacuum in the air/fuel mixing device.

12. The engine of claim 9, wherein the engine includes a breather and wherein a flow path extends from the breather to the flow guide to draw gas from the breather to the air/fuel mixing device.

13. The engine of claim 9, wherein the cover includes a resilient material that contacts the flow guide to at least partially enclose the channel.

14. The engine of claim 9, wherein the air/fuel mixing device is a carburetor.

15. An engine comprising:
a housing;
a piston/cylinder arrangement disposed at least partially within the housing and having a characteristic volume;
a carburetor coupled to the housing;
a heater box coupled to the housing, the heater box defining a space and including a flow limiter having a flow area that is related to the characteristic volume, the heater box in fluid communication with the carburetor; and
a muffler adjacent the housing and disposed adjacent the heater box, the muffler operable to heat air disposed within the space.

16. The engine of claim 15, wherein the piston/cylinder arrangement defines a combustion chamber, and wherein the characteristic volume is related to a volume of the combustion chamber.

17. The engine of claim 16, wherein the flow limiter defines a minimum flow area, and wherein the minimum flow area is related to a selected partial vacuum in the air/fuel mixing device.

18. The engine of claim 15, wherein the engine includes a breather and wherein a flow path extends from the breather to the heater box to draw gas from the breather to the heater box.

19. The engine of claim 15, wherein the heater box includes a cover and a flow guide, and wherein the cover includes a resilient material that contacts the flow guide to at least partially enclose the space.

20. The engine of claim 15, wherein the heater box includes a channel that provides fluid communication between the space and the carburetor, and wherein the flow limiter is formed as part of the channel.
